(19) United States
(12) Patent Application Publication
(10) Pub. No.: US 2014/0339145 A1
(43) Pub. Date: Nov. 20, 2014

(54) APPARATUS FOR PREVENTING ALGAE PROLIFERATION

(71) Applicant: Jong Hyung HUR, Nam-gu Ulsan (KR)

(72) Inventor: Jong Hyung Hur, Ulsan (KR)

(21) Appl. No.: 14/359,573

(22) PCT Filed: Nov. 13, 2012
(86) PCT No.: PCT/KR2012/009557

§ 371 Date: Jul. 30, 2014

(30) Foreign Application Priority Data
Nov. 21, 2011 (KR) 10-2011-0121445

(51) Int. Cl. C02F 1/00

(52) U.S. Cl. CPC C02F 1/00; C02F 2103/007
USPC 210/232; 210/242.1

(57) ABSTRACT

Disclosed is an apparatus for preventing algae proliferation including floats that float on the water; a frame-shaped underwater supporting structure that is provided with connecting wires so as to be disposed in water while being connected to one sides of the floats; an underwater film that is attached to the underwater supporting structure to be spread in a horizontal direction so as to reduce the amount of sunlight introduced in water under the underwater supporting structure, and that is provided with a circulating hole formed in one side to penetrate in a vertical direction to have permeability of water; and a float circulating unit that is provided with an impeller disposed in the circulating hole, and that selectively rotates the impeller in a clockwise direction or counterclockwise direction to allow underwater floats positioned above and under the underwater film to be circulated through the circulating hole.

### TECHNICAL FIELD

The present invention relates to an apparatus for preventing algae proliferation, and more particularly, to an apparatus for preventing algae proliferation that prevents algae from proliferating in a dam, a reservoir, or a lake.

### BACKGROUND ART

In general, industrial waste water or organic waste water are introduced into a river, a lake, a reservoir, or a dam due to environmental factors to allow nutrient salts to become abundant. For this reason, an abnormal proliferation phenomenon of plankton (an algal bloom or red tide phenomenon) is caused, so that dissolved oxygen in water is reduced and a poisonous gas is generated. As a result, for example, fishes and shellfishes suffocate, so that water quality change and ecological damage may be severed.

In order to prevent the proliferation of the algae, one condition of a water temperature, sunlight, and nutrient salts which are proliferation conditions of the algae is suppressed. A shielding film that floats on the water to shield the sunlight may be typically provided. However, when the sunlight is completely shielded, air and water surface are prevent from coming in contact with each other to reduce dissolved oxygen in water, so that water quality may be further deteriorated.

### DISCLOSURE

### Technical Problem

An object of the present invention is to provide an apparatus for preventing algae proliferation capable of preventing growth of algae to improve water quality without deteriorating the water quality.

### Technical Solution

An exemplary embodiment of the present invention provides an apparatus for preventing algae proliferation including floats that float on the water; a frame-shaped underwater supporting structure that is provided with connecting wires so as to be disposed in water while being connected to one sides of the floats; an underwater film that is attached to the underwater supporting structure to be spread in a horizontal direction so as to reduce the amount of sunlight introduced in water under the underwater supporting structure, and that is provided with a circulating hole formed in one side to penetrate in a vertical direction to have permeability of water; and a float circulating unit that is provided with an impeller disposed in the circulating hole, and that selectively rotates the impeller in a clockwise direction or counterclockwise direction to allow underwater floats positioned above and under the underwater film to be circulated through the circulating hole.

Further, engaging members provided with clamping loops may be coupled to one sides of the floats, and the connecting wires may be provided with a plurality of clamping rings that is spaced apart from each other in a longitudinal direction such that the connecting wires are selectively inserted into and engaged with the clamping loops while being connected to the engaging members.

Furthermore, protrusions may be provided at the underwater film so as to protrude upward and downward, upward, or downward.

Moreover, carriers may be provided at the underwater film and the protrusions.

In addition, the float circulating unit may include a connecting shaft that is connected to the impeller, and a driving motor that is connected to the connecting shaft to generate a driving power so as to rotate the impeller.

Moreover, a funnel-shaped floating suppressing member that increases moving resistance of the underwater supporting structure due to shaking of the float on the water to allow the underwater film to be stably maintained in a horizontal state in water may be connected to the underwater supporting structure.

Furthermore, microbial activity carriers may be provided at the underwater supporting structure.

### Advantageous Effects

According to an apparatus for preventing algae proliferation according to the present invention, after an underwater film is provided to be spread inside an underwater supporting structure in a horizontal direction, the underwater supporting structure is connected to floats to be positioned in water, and a float circulating unit allows underwater floats positioned above and under the underwater film to be circulated through a circulating hole of the float. Accordingly, the introduction of the sunlight is reduced under the underwater film with the underwater film as its center to prevent the algae proliferation and to circulate the underwater floats, so that it is possible to improve water quality.

### DESCRIPTION OF DRAWINGS

FIG. 1 is a perspective view of an apparatus for preventing algae proliferation according to an embodiment of the present invention.

FIG. 2 is a cross-sectional view illustrating a state where the apparatus of FIG. 1 is provided.

FIG. 3 is a plan view of an apparatus for preventing algae proliferation according to another embodiment of the present invention.

FIG. 4 is a plan view of an embodiment of an underwater film illustrated in FIG. 1.

FIG. 5 is a plan view of another embodiment of the underwater film illustrated in FIG. 1.

FIG. 6 is a perspective view of an apparatus for preventing algae proliferation according to still another embodiment of the present invention.

### BEST MODE

Hereinafter, preferred embodiments of the present invention will be described in detail with reference to the accompanying drawings.

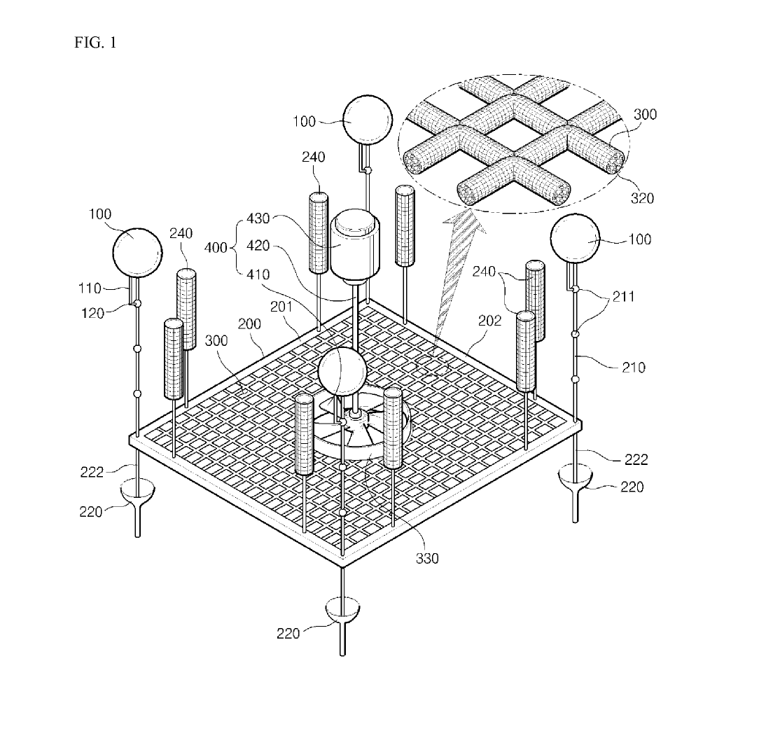

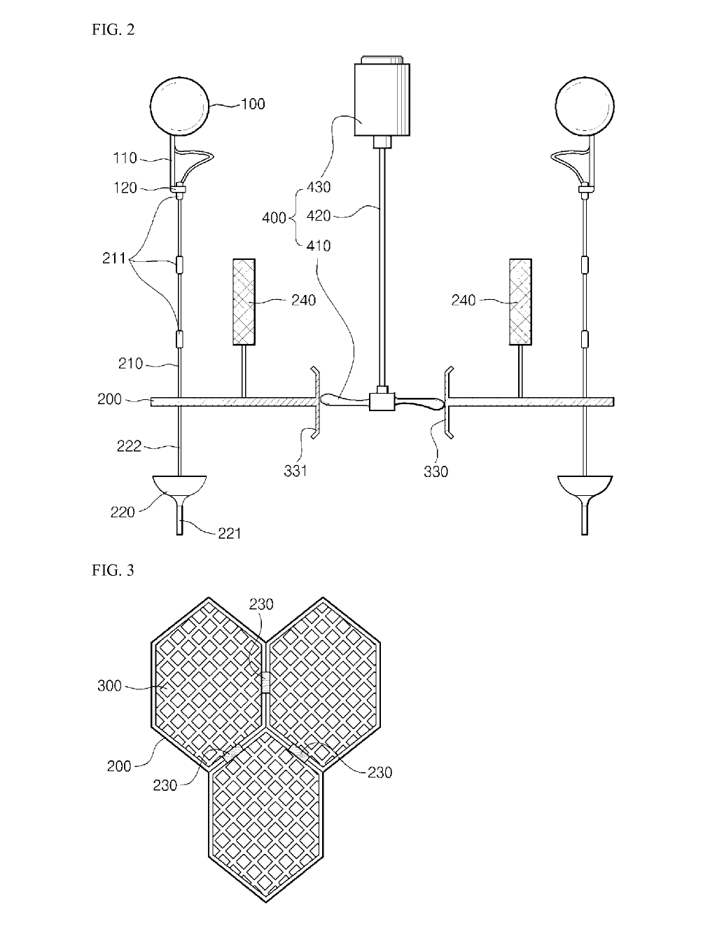

FIG. 1 is a perspective view of an apparatus for preventing algae proliferation according to an embodiment of the present invention, and FIG. 2 is a cross-sectional view illustrating a state where the apparatus of FIG. 1 is provided. Referring to FIGS. 1 and 2, the apparatus for preventing algae proliferation includes floats 100, an underwater supporting structure 200, and an underwater film 300.

The floats 100 are buoyancy members that float on the water to support the underwater supporting structure 200 to be described below such that the underwater supporting structure is disposed in water. It has been illustrated that the float 100 is a cylindrical member that fills with air therein, but the present invention is not limited thereto. A known buoyancy member having buoyancy allowing the member to float on the water may be selectively applied to the float.

Engaging members 110 to which connecting wires 210 of the underwater supporting structure 200 to be described below are connected are coupled to one sides of the floats 100. Here, a clamping loop 120 that is bent upward to allow the connecting wire 210 of the underwater supporting structure 200 to be engaged is formed on one side of the engaging member 110. That is, when the connecting wire 210 to be described below is selectively engaged with the clamping loop 120 in a longitudinal direction, a position of the underwater supporting structure 200 in a vertical direction in water can be adjusted.

The underwater supporting structure 200 is a frame-shaped member that allows the underwater film 300 to be described below to be maintained in a spread state while being disposed in water. That is, the underwater supporting structure 200 is connected to the floats 100 so as to be maintained in a state where the underwater supporting structure is disposed at a predetermined position in water.

Here, the connecting wires 210 are provided at the underwater supporting structure 200 so as to be disposed in water while being connected to one sides of the floats 100, that is, the engaging members 110. That is, while one end of the connecting wire 210 in the longitudinal direction is connected to one side of the underwater supporting structure 200, the other end thereof is connected to the engaging member 110 of the float 100. At this time, a plurality of clamping rings 211 is provided to be spaced apart from each other in the longitudinal direction of the connecting wire 210. The clamping rings 211 are selectively inserted to and engaged with the clamping loops 120 formed at the engaging member 110 of the floats 100 described above, so that the position of the underwater supporting structure 200 in the vertical direction in water can be adjusted.

Further, floating suppressing members 220 that suppress the under supporting structure 200 from raising due to shaking of the floats 100 on the water may be provided at the underwater supporting structure 200. Here, the floating suppressing member 220 has a funnel shape in which a discharge hole 221 is formed at a lower end thereof. Accordingly, the floating suppressing member 220 increases resistance when the underwater supporting structure 200 is raised to allow the underwater supporting structure 200 to be maintained in a stable horizontal state in water. In addition, floating materials in water can be discharged through the discharge holes 221 without being stacked up, so that the resistance generated when the underwater supporting structure is raised in water can be constantly maintained. Reference numeral 222 denotes a wire that connects the floating suppressing member 220 to the underwater supporting structure 200.

Moreover, it has been illustrated in the embodiment that the underwater supporting structure 200 has a rectangular frame shape formed by a plurality of transverse members 201 and a plurality of longitudinal members 202, but the present invention is not limited thereto. The underwater supporting structure may have a circular frame shape or a polygonal frame shape. Further, as illustrated in FIG. 3, the underwater supporting structure 200 is plural in number, the plurality of underwater supporting structures is arranged adjacent to each other in a horizontal direction, and the adjacent underwater supporting structures 200 are connected through brackets 230.

Moreover, microbial activity carriers 240 may be connected to the underwater supporting structure 200 so as to provide a space where protists or immobilization microorganisms having a preying function on algae adhere and inhabit. Here, it has been illustrated that the microbial activity carriers 240 are connected to the underwater supporting structure 200 so as to be arranged above the underwater supporting structure 200 in water, but the present invention is not limited thereto. The microbial activity carriers may be connected to the underwater supporting structure 200 to be arranged under the underwater supporting structure.

The underwater film 300 is a shielding member that suppresses sunlight from being introduced in water under the underwater supporting structure 200. That is, the underwater film 300 is attached to be spread inside the underwater supporting structure 200 in the horizontal direction, so that the sunlight introduced in water from the top is reflected or absorbed to reduce the amount of sunlight introduced under the underwater supporting structure 200.

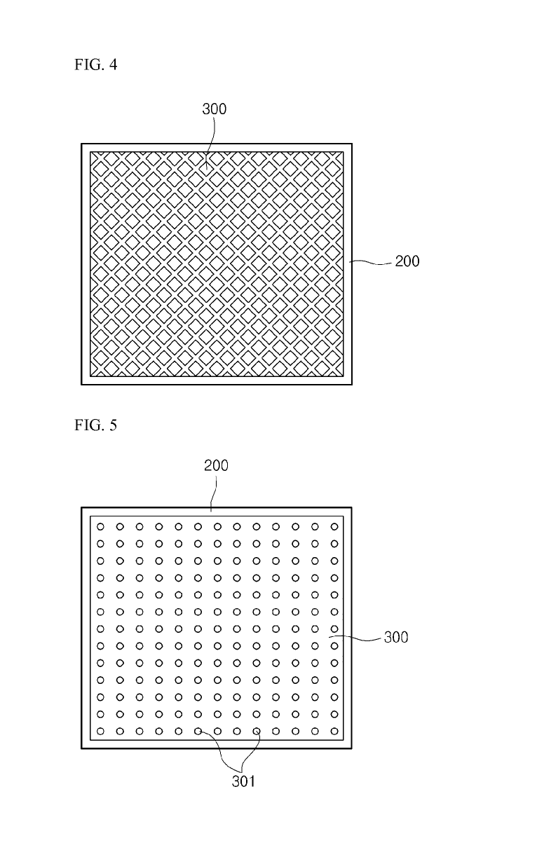

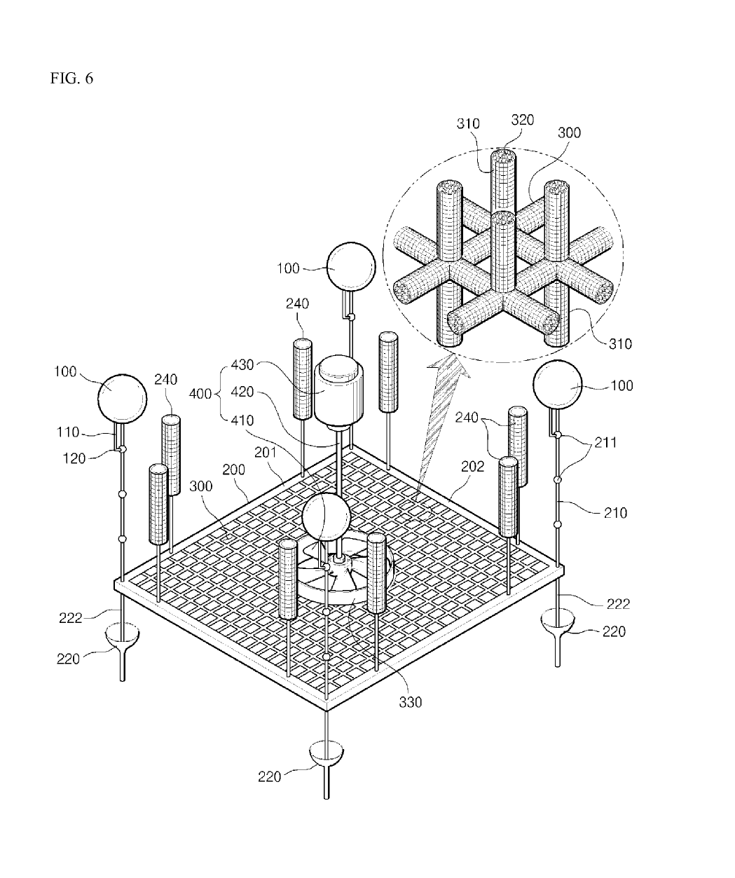

The underwater film 300 has permeability of water so as to allow the floats above and under the underwater supporting structure 200 to be circulated while reducing the amount of sunlight introduced under the underwater supporting structure 200. That is, although it has been illustrated that the underwater film 300 according to the embodiment has a mesh shape as illustrated in FIG. 4 so as to allow the sunlight to be introduced in water under the underwater supporting structure 200 and to have permeability of water, the present invention is not limited. The underwater film may be a plate member provided with a plurality of penetrating holes 301 as illustrated in FIG. 5. Furthermore, as illustrated in FIG. 6, protrusions 310 that protrude upward and downward may be formed at the underwater film 300. Carriers 311 may be provided at the protrusions 310 so as to provide a space where protists or immobilization microorganisms having a preying function on algae adhere and inhabit. At this time, porous carriers 320 may be provided at the underwater film 300 so as to provide a space where protists or immobilization microorganisms having a preying function on algae adhere and inhabit.

In addition, a circulating hole 330 is formed in one side of the underwater film 300 so as to dispose an impeller 410 of a float circulating unit 400 to be described below. That is, the circulating hole 330 is formed to penetrate one side of the underwater film 300 in the vertical direction to serve as a flow path in which underwater floats positioned above and under the underwater film 300 with the underwater film 300 as its center are circulated. Here, a guide pipe 331 may be coupled to the circulating hole 330 to be perpendicular to the underwater film 300 such that the impeller 410 of the float circulating unit 400 to be described below is disposed inside the guide pipe.

Moreover, a reflection member (not illustrated) may be coated on a top surface of the underwater film 300 so as to reflect the introduced sunlight upward. In this way, by using the underwater film 300, a water temperature above the underwater supporting structure 200 is maintained higher than a temperature at which the algae proliferates, or the proliferation of the algae is prevented by the strong sunlight. Further, a water temperature under the underwater supporting structure 200 is maintained lower than the temperature of the algae proliferation, or the amount of incident sunlight is decreased by the underwater film 300 to disturb photosynthesis of the algae, so that the proliferation of the algae is prevented.

The float circulating unit 400 allows the underwater floats positioned above and under the underwater film 300 with the underwater film 300 as its center to be circulated through the circulating hole 330 of the underwater film 300. That is, the float circulating unit 400 allows the underwater floats positioned above the underwater film 300 to be moved under the underwater film 300 through the circulating hole 330 or allows the underwater floats positioned under the underwater film 300 to be moved above the underwater film 300, so that water quality is improved by promoting the microorganisms adhering to the carriers 311 and 320 to come in contact with nutriments within the underwater floats. The float circulating unit 400 includes the impeller 410, a connecting shaft 420, and a driving motor 430.

The impeller 410 is disposed inside the circulating hole 330 of the underwater film 300 to generate moving force such that the underwater floats positioned above and under the underwater film 300 can be circulated depending on a rotational direction. The impeller 410 is rotated in a clockwise direction or a counterclockwise direction by the driving motor 430 to be described below to control a moving direction of the underwater floats.

The connecting shaft 420 is a shaft member that transmits a driving power of the driving motor 430 to be described below to the impeller 410. One end of the connecting shaft 420 in a longitudinal direction is connected to the impeller 410, and the other end thereof is connected to a rotational shaft of the driving motor 430.

The driving motor 430 generates a driving power so as to rotate the impeller 410. The driving motor 430 is connected to the impeller 410 through the connecting shaft 420 to allow the impeller 410 to be rotated in the clockwise direction or counterclockwise direction. Here, it has been illustrated that the driving motor 430 according to the embodiment is provided to float on the water while being connected to the impeller 410 by the connecting shaft 420, but the present invention is not limited thereto. The driving motor may be provided in water.

The apparatus for preventing algae proliferation according to the embodiment having the aforementioned configuration may be provided in a river, a lake, a reservoir, and a dam. At this time, the underwater supporting structure 200 is provided in water while being connected to the floats 100. Here, the position of the underwater supporting structure 200 in water can be adjusted by selectively clamping the clamping rings 211 of the connecting wires 210 to the clamping loops 120 of the floats 100.

When the underwater supporting structure 200 is provided to be positioned in water, the underwater film 300 provided inside the underwater supporting structure 200 to be spread in the horizontal direction reduces the amount of sunlight introduced under the underwater supporting structure 200. That is, the sunlight introduced in the water collides with the underwater film 300 to be absorbed or reflected upward, and only a part of the sunlight passing through the underwater film 300 is introduced under the underwater supporting structure 200. Accordingly, the water temperature above the underwater film 300 with the underwater film as its center is higher than a temperature for proliferating the algae and the water temperature under the underwater film is lower than the temperature for proliferating the algae, so that the proliferation of the algae is disturbed as a whole.

Furthermore, the impeller 410 of the float circulating unit 400 is rotated in the clockwise direction or counterclockwise direction by the driving motor 430, and the underwater floats positioned above and under the underwater film 300 are circulated through the circulating hole 330 of the underwater film 300. Accordingly, by promoting the microorganisms adhering to the carriers 311 and 320 to come in contact with the nutriments within the underwater floats, it is possible to improve water quality.

In this way, in the apparatus for preventing algae proliferation of the embodiment, after the underwater film 300 is provided to be spread inside the underwater supporting structure 200 in the horizontal direction, the underwater supporting structure 200 is connected to the floats 100 to be positioned in water, and the float circulating unit 400 allows the underwater floats positioned above and under the underwater film 300 to be circulated through the circulating hole 330 of the floats 100. Accordingly, the introduction of the sunlight is reduced under the underwater film 300 with the underwater film as its center to prevent the algae proliferation and to circulate the underwater floats, so that the microorganisms adhering to the carriers 311 and 320 are prompted to come in contact with the nutriments within the underwater floats. As a result, it is possible to improve the water quality.

Although the present invention has been described in connection with the embodiments illustrated in the drawings, the embodiments are merely examples. It should be understood to those skilled in the art that various modifications and equivalents to the embodiments are possible. Accordingly, the technical scope of the present invention should be defined by the technical spirit of the appended claims.

1. An apparatus for preventing algae proliferation, comprising:
floats that float on the water;
a frame-shaped underwater supporting structure that is provided with connecting wires so as to be disposed in water while being connected to one sides of the floats;
an underwater film that is attached to the underwater supporting structure to be spread in a horizontal direction so as to reduce the amount of sunlight introduced in water under the underwater supporting structure, and that is provided with a circulating hole formed in one side to penetrate in a vertical direction to have permeability of water; and
a float circulating unit that is provided with an impeller disposed in the circulating hole, and that selectively rotates the impeller in a clockwise direction or counterclockwise direction to allow underwater floats positioned above and under the underwater film to be circulated through the circulating hole.

2. The apparatus for preventing algae proliferation of claim 1,
wherein engaging members provided with clamping loops are coupled to one sides of the floats, and
the connecting wires are provided with a plurality of clamping rings that is spaced apart from each other in a longitudinal direction such that the connecting wires are selectively inserted into and engaged with the clamping loops while being connected to the engaging members.

3. The apparatus for preventing algae proliferation of claim 1,
wherein protrusions are provided at the underwater film so as to protrude upward and downward, upward, or downward.

4. The apparatus for preventing algae proliferation of claim 1, wherein carriers are provided at the underwater film and the protrusions.

5. The apparatus for preventing algae proliferation of claim 1,
wherein the float circulating unit includes
a connecting shaft that is connected to the impeller, and
a driving motor that is connected to the connecting shaft to generate a driving power so as to rotate the impeller.

6. The apparatus for preventing algae proliferation of claim 1, wherein a funnel-shaped floating suppressing member that increases moving resistance of the underwater supporting structure due to shaking of the float on the water to allow the underwater film to be stably maintained in a horizontal state in water is connected to the underwater supporting structure.

7. The apparatus for preventing algae proliferation of claim 1, wherein microbial activity carriers are provided at the underwater supporting structure.

8. The apparatus for preventing algae proliferation of claim 3, wherein carriers are provided at the underwater film and the protrusions.

9. The apparatus for preventing algae proliferation of claim 6, wherein microbial activity carriers are provided at the underwater supporting structure.
